(19) United States
(12) Patent Application Publication
(10) Pub. No.: US 2016/0269087 A1
(43) Pub. Date: Sep. 15, 2016

(54) SIGNALING FOR MILLIMETER WAVE INTERFERENCE AND SCHEDULING

(71) Applicant: QUALCOMM Incorporated, San Diego, CA (US)

(72) Inventors: Sundar Subramanian, Bridgewater, NJ (US); Jung Ho Ryu, Jersey City, NJ (US); Muhammad Nazmul Islam, Piscataway, NJ (US); Ashwin Sampath, Skillman, NJ (US); Junyi Li, Chester, NJ (US); Thomas Joseph Richardson, South Orange, NJ (US)

(21) Appl. No.: 14/828,726

(22) Filed: Aug. 18, 2015

Related U.S. Application Data
(60) Provisional application No. 62/132,365, filed on Mar. 12, 2015.

(51) Int. Cl. H04B 7/06; H04L 12/26; H04W 72/08; H04W 72/04; H04W 52/22

(52) U.S. Cl. CPC H04B 7/0617; H04B 7/0632; H04W 72/0473; H04W 52/22; H04W 72/082; H04L 43/045

(57) ABSTRACT

Methods, systems, and devices are described for wireless communication. A serving base station may transmit a signal to user equipment (UE) using directional beamforming. The UE may receive the transmission from the serving base station and may also receive a signal from a neighbor base station using directional beamforming. The UE may then generate an interference report based on the two transmissions, and send report to the serving base station. The serving base station may generate a local interference graph based on the interference report, exchange interference information with the neighbor base station(s), and schedule subsequent transmissions to the UE based on the exchanged interference information. In some cases, the scheduling is based on distributed information exchange and prioritization. In other cases, the scheduling may be managed by a centralized controller.

### CROSS REFERENCES

The present Application for Patent claims priority to U.S. Provisional Patent Application No. 62/132,365 by Subramanian et al., entitled “Signaling for Millimeter Wave Interference and Scheduling,” filed Mar. 12, 2015, assigned to the assignee hereof, and expressly incorporated by reference herein.

### BACKGROUND

1. Field of Disclosure

The following relates generally to wireless communication, and more specifically to signaling for millimeter wave (mmW) interference and scheduling.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system).

By way of example, a wireless multiple-access communications system may include a number of base stations, each simultaneously supporting communication for multiple communication devices, which may be otherwise known as user equipments (UEs). A base station may communicate with the communication devices on downlink channels (e.g., for transmissions from a base station to a UE) and uplink channels (e.g., for transmissions from a UE to a base station).

Some wireless networks, such as networks incorporating mmW based communications, utilize directional beamforming to increase the range or quality of communication links. In some cases, neighboring base stations using directional beamforming may interfere with each other if they transmit toward each other. This may result in lost communications or reduced throughput.

### SUMMARY

A serving base station may transmit a signal to user equipment (UE) using directional beamforming. The UE may receive the transmission from the serving base station and may also receive a signal from a neighbor base station using directional beamforming. The UE may then generate an interference report based on the two transmissions, and send the report to the serving base station. The serving base station may generate a local interference graph based on the interference report, exchange interference information with the neighbor base station(s), and schedule subsequent transmissions to the UE based on the exchanged interference information. In some cases, the scheduling may be based on distributed information exchange and prioritization. In other cases, the scheduling may be managed by a centralized controller.

A method of wireless communication is described. The method may include receiving a first transmission from a first beam of a serving base station using directional beamforming, receiving a second transmission from a second beam of a neighboring base station using directional beamforming, generating an interference report based at least in part on the first transmission and the second transmission, and transmitting the interference report to the serving base station.

An apparatus for wireless communication is described. The apparatus may include means for receiving a first transmission from a first beam of a serving base station using directional beamforming, means for receiving a second transmission from a second beam of a neighboring base station using directional beamforming, means for generating an interference report based at least in part on the first transmission and the second transmission, and means for transmitting the interference report to the serving base station.

A further apparatus for wireless communication is described. The apparatus may include a processor, memory in electronic communication with the processor, and instructions stored in the memory and operable, when executed by the processor, to cause the apparatus to receive a first transmission from a first beam of a serving base station using directional beamforming, receive a second transmission from a second beam of a neighboring base station using directional beamforming, generate an interference report based at least in part on the first transmission and the second transmission, and transmit the interference report to the serving base station.

A non-transitory computer-readable medium storing code for wireless communication is described. The code may include instructions executable to receive a first transmission from a first beam of a serving base station using directional beamforming, receive a second transmission from a second beam of a neighboring base station using directional beamforming, generate an interference report based at least in part on the first transmission and the second transmission, and transmit the interference report to the serving base station.

Some examples of the method, apparatuses, or non-transitory computer-readable medium described herein may further include processes, features, means, instructions, or code for identifying a base station ID based at least in part on the first transmission or the second transmission. Additionally or alternatively, some examples may include processes, features, means, instructions, or code for determining a transmission power level based at least in part on the first transmission or the second transmission.

Some examples of the method, apparatuses, or non-transitory computer-readable medium described herein may further include processes, features, means, instructions, or code for identifying a beam ID based at least in part on the first transmission or the second transmission, wherein the interference report comprises the beam ID. Additionally or alternatively, in some examples the first transmission or the second transmission may be a directional broadcast signal.

In some examples of the method, apparatuses, or non-transitory computer-readable medium described herein, the first transmission or the second transmission may be a directional primary synchronization signal (PSS). Additionally or alternatively, in some examples the first transmission or the second transmission may be a data transmission.

In some examples of the method, apparatuses, or non-transitory computer-readable medium described herein, the first transmission or the second transmission may identify a beam traffic load. Additionally or alternatively, in some examples the first beam and the second beam may be mmW beams.

A method of wireless communication is described. The method may include transmitting a signal to a wireless device using a first beam of a directional beamforming configuration, receiving an interference report from the wireless device based at least in part on the transmission of the signal, and generating a local interference graph based at least in part on the interference report.

An apparatus for wireless communication is described. The apparatus may include means for transmitting a signal to a wireless device using a first beam of a directional beamforming configuration, means for receiving an interference report from the wireless device based at least in part on the transmission of the signal, and means for generating a local interference graph based at least in part on the interference report.

A further apparatus for wireless communication is described. The apparatus may include a processor, memory in electronic communication with the processor, and instructions stored in the memory and operable, when executed by the processor, to cause the apparatus to transmit a signal to a wireless device using a first beam of a directional beamforming configuration, receive an interference report from the wireless device based at least in part on the transmission of the signal, and generate a local interference graph based at least in part on the interference report.

A non-transitory computer-readable medium storing code for wireless communication is described. The code may include instructions executable to transmit a signal to a wireless device using a first beam of a directional beamforming configuration, receive an interference report from the wireless device based at least in part on the transmission of the signal, and generate a local interference graph based at least in part on the interference report.

Some examples of the method, apparatuses, or non-transitory computer-readable medium described herein may further include processes, features, means, instructions, or code for exchanging interference information with a neighboring base station based at least in part on the local interference graph. Additionally or alternatively, some examples may include processes, features, means, or instructions for scheduling a transmission based at least in part on the exchanged interference information.

In some examples of the method, apparatuses, or non-transitory computer-readable medium described herein, the scheduling may be performed in a distributed manner. Additionally or alternatively, some examples may include processes, features, means, instructions, or code for exchanging scheduling information with the neighboring base station, wherein scheduling the transmission is based at least in part on the exchanged scheduling information.

In some examples of the method, apparatuses, or non-transitory computer-readable medium described herein, the scheduling is based at least in part on a base station priority. Additionally or alternatively, in some examples the base station priority is based at least in part on a traffic load, or a random seed, or the interference information, or a UE wait time, or a combination thereof.

In some examples of the method, apparatuses, or non-transitory computer-readable medium described herein, the scheduling is based at least in part on a UE priority. Additionally or alternatively, in some examples the UE priority is based at least in part on a traffic load, or a random seed, or the interference information, or a UE wait time, or a combination thereof.

In some examples of the method, apparatuses, or non-transitory computer-readable medium described herein, the scheduling is based at least in part on a centralized controller. Additionally or alternatively, some examples may include processes, features, means, instructions, or code for transmitting at least traffic demand information, or local interference information, or a combination thereof to the centralized controller, and receiving scheduling information from the centralized controller, wherein the scheduling is based at least in part on the received scheduling information.

In some examples of the method, apparatuses, or non-transitory computer-readable medium described herein, the interference information comprises information about at least one beam that interferes with a beam of a neighbor base station. Additionally or alternatively, some examples may include processes, features, means, instructions, or code for updating the local interference graph based at least in part on the interference information.

In some examples of the method, apparatuses, or non-transitory computer-readable medium described herein, the interference information is exchanged via a wired backhaul link. Additionally or alternatively, in some examples the interference information is exchanged via a mmW backhaul link.

In some examples of the method, apparatuses, or non-transitory computer-readable medium described herein, the signal is a directional broadcast signal. Additionally or alternatively, in some examples the signal is a directional PSS.

In some examples of the method, apparatuses, or non-transitory computer-readable medium described herein, the signal is a data transmission signal. Additionally or alternatively, in some examples the signal comprises at least a base station ID, or a beam number, or a transmission power level, or a beam load indicator, or a combination thereof.

In some examples of the method, apparatuses, or non-transitory computer-readable medium described herein, the interference report comprises at least a transmission power level, or a reception power level, or a base station ID, or a beam number, or a combination thereof. Additionally or alternatively, in some examples the first beam is a mmW beam.

The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communications system that supports signaling for millimeter wave (mmW) interference and scheduling in accordance with various aspects of the present disclosure;

FIG. 2 illustrates an example of a wireless communications subsystem that supports signaling for mmW interference and scheduling in accordance with various aspects of the present disclosure;

FIG. 3 illustrates an example of a wireless communications subsystem that supports signaling for mmW interference and scheduling in accordance with various aspects of the present disclosure;

FIG. 4 illustrates an example of a process flow that supports signaling for mmW interference and scheduling in accordance with various aspects of the present disclosure;

FIG. 5 shows a block diagram of a wireless device that supports signaling for mmW interference and scheduling in accordance with various aspects of the present disclosure;

FIG. 6 shows a block diagram of a wireless device that supports signaling for mmW interference and scheduling in accordance with various aspects of the present disclosure;

FIG. 7 shows a block diagram of a wireless device that supports signaling for mmW interference and scheduling in accordance with various aspects of the present disclosure;

FIG. 8 illustrates a block diagram of a system including a user equipment (UE) that supports signaling for mmW interference and scheduling in accordance with various aspects of the present disclosure;

FIG. 9 shows a block diagram of a wireless device that supports signaling for mmW interference and scheduling in accordance with various aspects of the present disclosure;

FIG. 10 shows a block diagram of a wireless device that supports signaling for mmW interference and scheduling in accordance with various aspects of the present disclosure;

FIG. 11 shows a block diagram of a wireless device that supports signaling for mmW interference and scheduling in accordance with various aspects of the present disclosure;

FIG. 12 illustrates a block diagram of a system including a base station that supports signaling for mmW interference and scheduling in accordance with various aspects of the present disclosure;

FIG. 13 illustrates a method for signaling for mmW interference and scheduling in accordance with various aspects of the present disclosure;

FIG. 14 illustrates a method for signaling for mmW interference and scheduling in accordance with various aspects of the present disclosure;

FIG. 15 illustrates a method for signaling for mmW interference and scheduling in accordance with various aspects of the present disclosure;

FIG. 16 illustrates a method for signaling for mmW interference and scheduling in accordance with various aspects of the present disclosure;

FIG. 17 illustrates a method for signaling for mmW interference and scheduling in accordance with various aspects of the present disclosure; and

FIG. 18 illustrates a method for signaling for mmW interference and scheduling in accordance with various aspects of the present disclosure.

### DETAILED DESCRIPTION

A user equipment (UE) may receive a directional transmission from a serving base station and may also receive a directional transmission from a neighbor base station. The UE may then generate an interference report based on the two transmissions, and send the report to the serving base station. The serving base station may generate a local interference graph based on the interference report, exchange interference information with the neighbor base station(s), and schedule subsequent transmissions to the UE based on the exchanged interference information.

Aspects of the disclosure are described in the context of a wireless communications system. In some cases, the wireless communications system is a millimeter wave (mmW) system, but the methods and apparatuses described may also be used in the context of other wireless networks that utilize directional beamforming. The disclosure is further illustrated by and described with reference to apparatus diagrams, system diagrams, and flowcharts that relate to signaling for mmW interference and scheduling.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

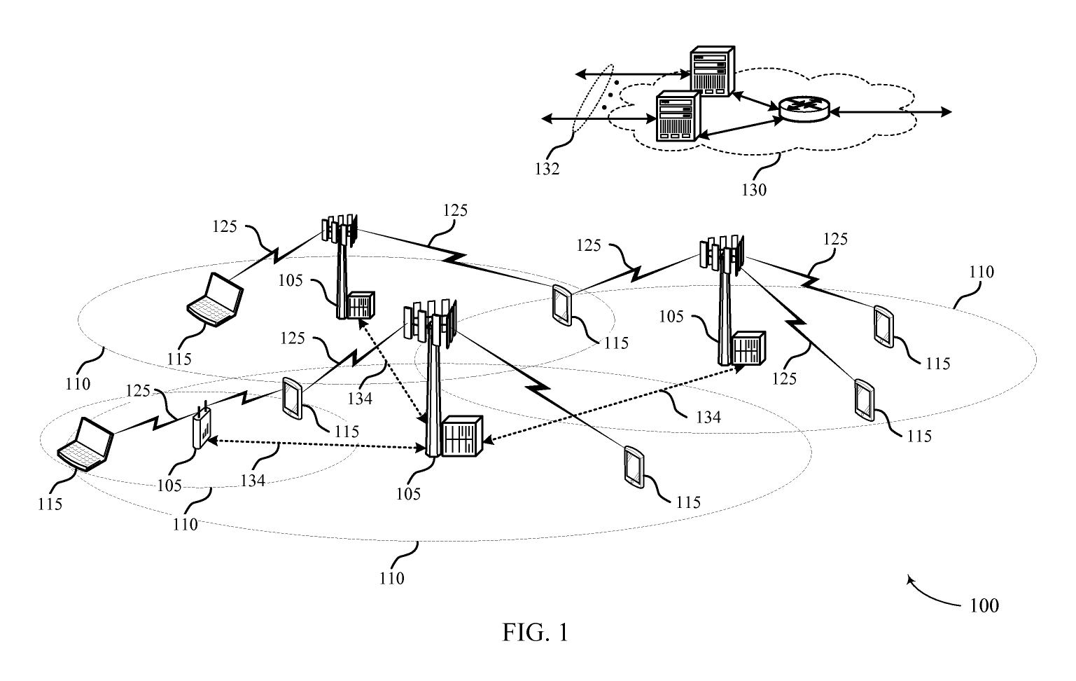

FIG. 1 illustrates an example of a wireless communications system 100 in accordance with various aspects of the present disclosure. The wireless communications system 100 includes base stations 105, at least one UE 115, and a core network 130. The core network 130 may provide user authentication, access authorization, tracking, internet protocol (IP) connectivity, and other access, routing, or mobility functions. The base stations 105 interface with the core network 130 through backhaul links 132 (e.g., S1, etc.). The base stations 105 may perform radio configuration and scheduling for communication with the UEs 115, or may operate under the control of a base station controller (not shown). In various examples, the base stations 105 may communicate, either directly or indirectly (e.g., through core network 130), with one another over backhaul links 134 (e.g., X1, etc.), which may be wired or wireless communication links.

The base stations 105 may wirelessly communicate with the UEs 115 via one or more base station antennas. Each of the base stations 105 may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro or small cell base stations). There may be overlapping geographic coverage areas 110 for different technologies.

In some examples, the wireless communications system 100 is a Long Term Evolution (LTE)/LTE-Advanced (LTE-A) network. In LTE/LTE-A networks, the term evolved node B (eNB) may be generally used to describe the base stations 105, while the term UE may be generally used to describe the UEs 115. The wireless communications system 100 may be a heterogeneous LTE/LTE-A network in which different types of eNBs provide coverage for various geographical regions. For example, each eNB or base station 105 may provide communication coverage for a macro cell, a small cell, or other types of cell. The term “cell” is a term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs 115 with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

The communication networks that may accommodate some of the various disclosed examples may be packet-based networks that operate according to a layered protocol stack and data in the user plane may be based on the IP. A radio link control (RLC) layer may perform packet segmentation and reassembly to communicate over logical channels. A medium access control (MAC) layer may perform priority handling and multiplexing of logical channels into transport channels. The MAC layer may also use hybrid automatic repeat request (HARD) to provide retransmission at the MAC layer to improve link efficiency. In the control plane, the radio resource control (RRC) protocol layer may provide establishment, configuration, and maintenance of an RRC connection between a UE 115 and the base stations 105. The RRC protocol layer may also be used for core network 130 support of radio bearers for the user plane data. At the physical (PHY) layer, the transport channels may be mapped to physical channels.

The UEs 115 may be dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment including macro eNBs, small cell eNBs, relay base stations, and the like.

The communication links 125 shown in wireless communications system 100 may include uplink (UL) transmissions from a UE 115 to a base station 105, or downlink (DL) transmissions, from a base station 105 to a UE 115. The downlink transmissions may also be called forward link transmissions while the uplink transmissions may also be called reverse link transmissions. Each of the communication links 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using frequency division duplex (FDD) (e.g., using paired spectrum resources) or time division duplex (TDD) operation (e.g., using unpaired spectrum resources). Frame structures may be defined for FDD (e.g., frame structure type 1) and TDD (e.g., frame structure type 2).

In some examples of the wireless communications system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple input multiple output (MIMO) techniques that may take advantage of multi-path environments to transmit multiple spatial layers carrying the same or different coded data.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

Wireless communications system 100 may operate in an ultra high frequency (UHF) frequency region using frequency bands from 700 MHz to 2600 MHz (2.6 GHz), although in some cases wireless local area network (WLAN) networks may use frequencies as high as 4 GHz. This region may also be known as the decimeter band, since the wavelengths range from approximately one decimeter to one meter in length. UHF waves may propagate mainly by line of sight, and may be blocked by buildings and environmental features. However, the waves may penetrate walls sufficiently to provide service to UEs 115 located indoors. Transmission of UHF waves is characterized by smaller antennas and shorter range (e.g., less than 100 km) compared to transmission using the smaller frequencies (and longer waves) of the high frequency (HF) or very high frequency (VHF) portion of the spectrum. In some cases, wireless communications system 100 may also utilize extremely high frequency (EHF) portions of the spectrum (e.g., from 30 GHz to 300 GHz). This region may also be known as the millimeter band, since the wavelengths range from approximately one millimeter to one centimeter in length. Thus, EHF antennas may be even smaller and more closely spaced than UHF antennas. In some cases, this may facilitate use of antenna arrays within a UE 115 (e.g., for directional beamforming). However, EHF transmissions may be subject to even greater atmospheric attenuation and shorter range than UHF transmissions. Thus, mmW systems may rely on directional beamforming to increase the coverage area.

Multipath propagation may be caused by different copies of a wireless signal reaching a receiver via different paths with varying path lengths. The different path lengths may be based on, for example, atmospheric reflection and refraction, or reflection from buildings, water, and other surfaces. Multipath propagation may result in a time delay (or a phase shift) for one copy of a signal, which cause constructive or destructive interference (between consecutive symbols, inter-symbol interference (ISI), or within a single symbol). A guard interval (GI) (which may include a cyclic prefix) may be prepended to transmissions to mitigate the effects of channel spreading caused by multipath propagation. In some cases, multipath propagation may also impact the direction that a base station 105 utilizing directional beamforming selects to communicate with a UE 115. For example, a beam may be selected that is aimed directly toward a UE 115 if it reaches the UE 115 via reflection off a solid surface. In other cases, multipath propagation may result in interference at a UE 115 that is not the intended target of communication and not in the original propagation direction.

A UE 115 attempting to access a wireless network may perform an initial cell search by detecting a primary synchronization signal (PSS) from a base station 105. The PSS may enable synchronization of slot timing and may indicate a physical layer identity value. The UE 115 may then receive a secondary synchronization signal (SSS). The SSS may enable radio frame synchronization, and may provide a cell identity value, which may be combined with the physical layer identity value to identify the cell. The SSS may also enable detection of a duplexing mode and a cyclic prefix length. Some systems, such as TDD systems, may transmit an SSS but not a PSS. In some cases, both the PSS and the SSS may be located in the central 62 and 72 subcarriers of a carrier, respectively. In some cases, either the PSS of the SSS may be a directional transmission (i.e., a directional PSS (DPSS)). In some cases, a DPSS may be used to convey information about the beam used for transmission. That is, the periodicity and continuous transmission of DPSS beacon sequences may make them appropriate for measuring interference and generating local interference graphs.

After receiving the PSS and SSS, the UE 115 may receive a master information block (MIB), which may be transmitted in the physical broadcast channel (PBCH). The MIB may contain system bandwidth information, a system frame number (SFN), and a physical HARQ indicator channel (PHICH) configuration. After decoding the MIB, the UE 115 may receive one or more system information block (SIBs). For example, SIB1 may contain cell access parameters and scheduling information for other SIBs. Decoding SIB1 may enable the UE 115 to receive SIB2. SIB2 may contain RRC configuration information related to random access channel (RACH) procedures, paging, physical uplink control channel (PUCCH), physical uplink shared channel (PUSCH), power control, sounding reference signals (SRS), and cell barring. Once a UE 115 obtains the RACH information, it may proceed to establish a connection (e.g., an RRC configuration) with a base station 105.

Upon establishing a connection, a base station 105 may provide a UE 115 with a measurement reporting configuration as part of an RRC configuration. The measurement reporting configuration may include parameters related to which neighbor cells and frequencies the UE 115 should measure, criteria for sending measurement reports, intervals for transmission of measurement reports (i.e., measurement gaps), and other related information. In some cases, measurement reports may be triggered by events related to the channel conditions of the serving cells or the neighbor cells. In some examples, the measurement reporting configuration may also include a configuration for reporting interference specific to other base stations (and in some cases, specific to certain beams of a directional beamforming configuration).

Thus, a UE 115 may receive a directional transmission such as a DPSS from the serving base station 105 and may also receive a directional transmission from a neighbor base station 105. The UE 115 may then generate an interference report based on the two transmissions, and send report to the serving base station 105. The serving base station 105 may generate a local interference graph based on the interference report, exchange interference information with the neighbor base station(s) 105, and schedule subsequent transmissions to the UE 115 based on the exchanged interference information.

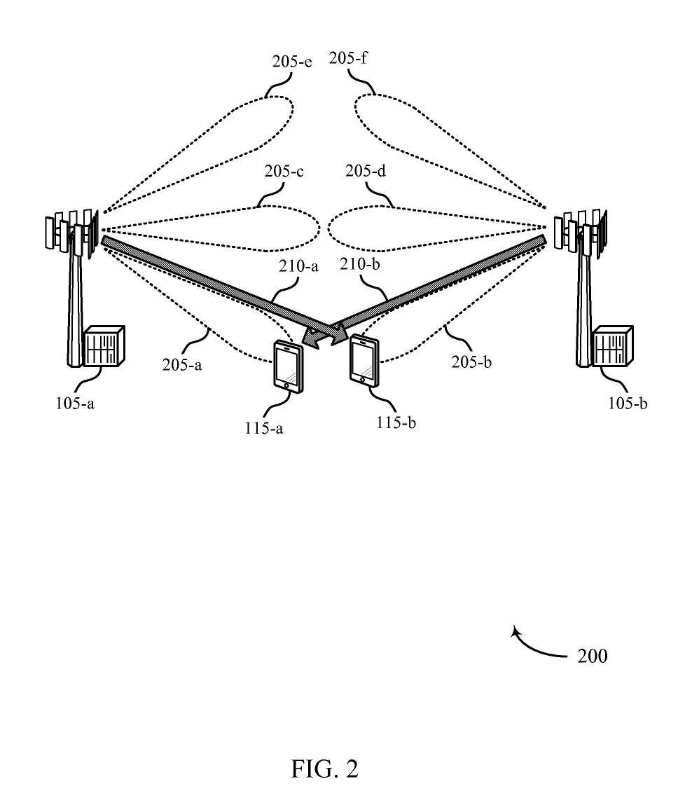

FIG. 2 illustrates an example of a wireless communications subsystem 200 for signaling for mmW interference and scheduling in accordance with various aspects of the present disclosure. Wireless communications subsystem 200 may include UE 115-a and 115-b, and base stations 105-a and 105-b, which may be examples of UEs 115 and base station 105 described with reference to FIG. 1. Base stations 105-a and 105-b may select a beam 205 appropriate for communicating with UE 115-a and 115-b. Thus, base station 105-a may communicate with UE 115-a using a beam 205-a, and may cause interference 210-a at UE 115-b. Conversely, base station 105-b may communicate with UE 115-b via beam 205-b and cause interference 210-b at UE 115-a. In some cases, beams 205 may be organized according to a regular distribution. For example, N beams 205 may be spaced 360/N° apart. In other cases, the beams may be organized according to an irregular distribution based on channel conditions or traffic load.

UE 115-a may evaluate interference 210-b and send an interference report to base station 105-a. Base station 105-a may collect interference information from UE 115-a, other UEs 115 in its coverage area, and neighboring base station 105 such as base station 105-b. Base station 105-a may then generate a local interference graph and schedule transmissions to mitigate the interference.

In some cases, a signal such as a DPSS may be used for interference measurement. That is, UEs 115-a and 115-b may receive a DPSS from both base station 105-a and 105-b and use the information to generate the interference report. Assignment/allocation symbols, dedicated pilots, or data transmission signals can also be used for interference. The assignment symbol and pilot symbols can be made base station specific so that they may be distinguished. In some cases, UEs 115-a and 115-b may measure interference as it happens during packet transmission (i.e., reactive interference measurement). In other cases, UEs 115-a and 115-b can measure potential interference in unscheduled slots not scheduled (i.e., proactive interference measurement). In some cases, acknowledgement (ACK) responses may also be synchronized and made base station specific to enable interference observation.

The signals used for interference estimation (e.g., a DPSS) may include information fields that may facilitate the estimation. For example, an interference measurement signal that is transmitted in beam 205-b may embed information that UE 115-a can use to determine a base station ID, a beam ID, a transmission power, a power offset (from data), and a measure of the number of UEs 115 communicating in that beam (i.e., the beam load).

UE 115-a may then use the interference measurement signal to compute the receive power of the interference measurement signal coming from base station 105-b on beam 205-b at the given transmit power. Based on the interference measurement signals detected and their received power, UE 115-a can determine whether transmissions on beam 205-b from base station 105-b at a given transmit power may conflict with transmissions from base station 105-a using beam 205-a due to interference 210-b.

UE 115-a may send a report to base station 105-a. The report may contain information relevant to beams 205-a and 205-b such as the transmit power, the received power, the beam IDs, and the base station ID. Base station 105-a may then collect interference measurements from each attached UE 115, and exchange information with base station 105-b and other neighboring base station 105. The exchange may take place over a wired interface (such as an X2 backhaul) or using wireless backhaul links. The gathered information may be compiled into a local interference graph. The local interference graph may relate each beam 205 to interfering beams of neighboring base stations. The local interference graph may change continuously as channels change. For example, obstacles such as vehicles may move through the coverage area and effect the propagation path(s) of each beam.

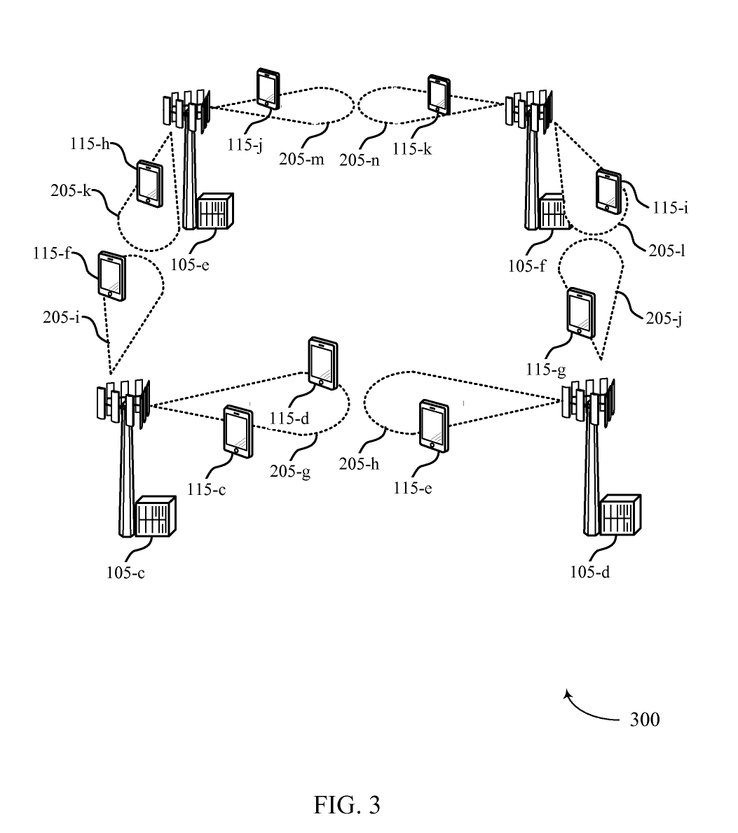

FIG. 3 illustrates an example of a wireless communications subsystem 300 for signaling for mmW interference and scheduling in accordance with various aspects of the present disclosure. Wireless communications subsystem 300 may include a UEs 115-c through 115-k as well as base stations 105-c through 105-f, which may be examples of UE 115 and base stations 105 described with reference to FIGS. 1-2. Base stations 105 and UEs 115 may communicate using directional beamforming operations via beams 205-g through 205-n.

Base station 105-c through 105-f may coordinate interference and scheduling information. The scheduling coordination may be either distributed or centrally managed. In distributed coordination, each base station 105 may determine a priority and they may take turns selecting a beam and a transmit power. The priority levels may be selected randomly or based on criteria such as traffic load or previous priority levels. After scheduling a transmission, the current base station 105 may share the information with one or more subsequent base stations 105, and the next in line may schedule a transmission that does not interfere with any previously scheduled transmissions.

In some cases, each base station 105 has a token with a priority number. A base station 105 with a higher priority number gets to choose a beam (or set of beams) first. Then the base stations 105 may tell each other what priority number they have. Each base station 105 must receive a beam choice from previous base stations 105 with higher priority number before it chooses its own beam. In some cases, base stations 105 may trade their tokens with other base stations 105. The larger the number of allowed directions, the more likely it may be to find a user with a non-empty buffer in an allowed direction. A larger the number of directions may also result in more spatial reuse.

For example, base station 105-c through 105-f may contend per timeslot for a set of beams based on a randomized priority procedure. Suppose that the prioritization is base station 105-c first, base station 105-d second, base station 105-e third, and base station 105-f fourth. Base station 105-c may select a beam 205-g to communicate with UE 115-c, UE 115-d or both. This selection may be based on traffic load, traffic type, time since each of the attached UEs 115 has received a transmission, or other factors. Base station 105-d may then schedule a transmission using beam 205-j because beam 205-h may interfere with the previously scheduled transmissions on beam 205-g.

Base station 105-e may then schedule a transmission freely if it will not interfere with previously scheduled transmissions. In one example, base station 105-e may schedule a transmission to UE 115-j using beam 205-m. In some cases, base station 105-e may schedule a low power transmission (e.g., if UE 115-j is located nearby). Base station 105-f may then schedule a transmission based on all of the previously scheduled transmissions. In some cases, base station 105-f may not be able to schedule a transmission without interfering with another base station 105, and may remain idle. However, in some cases, base station 105-f may schedule a low power transmission that may not interfere with another transmission in the same direction. For example, if base station 105-e scheduled a low power transmission to nearby UE 115-j, base station 105-f may be able to schedule a low power transmission to nearby UE 115-k without causing undue interference.

In a centralized scheduling scheme, each base station 105 may send current traffic demand information and local interference graph information to a centralized controller (which may be a base station 105 or another network entity). The centralized controller may constructs global interference graph information and develop a schedule based on current traffic demand and the global interference graph information. That is the centralized controller may coordinate scheduling to minimize interference and maximize network capacity. In some cases, the schedule can be semi-static (that is, it may change over a slower timescale compared to changes in channel conditions or scheduling timetables.)

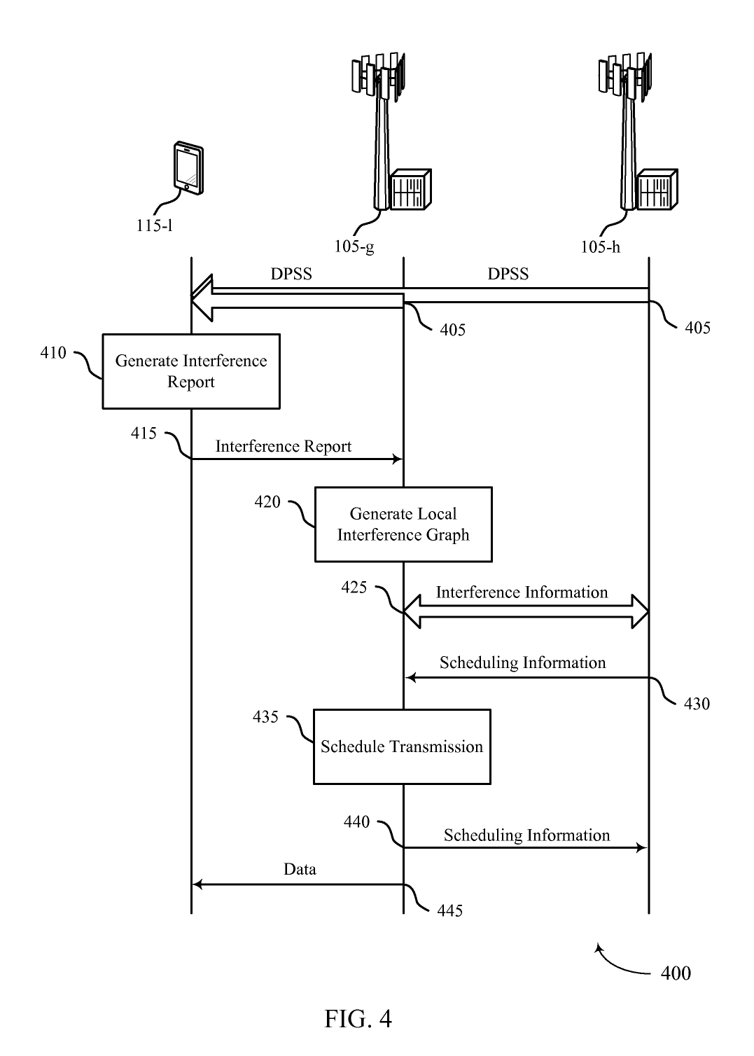

FIG. 4 illustrates an example of a process flow 400 for signaling for mmW interference and scheduling in accordance with various aspects of the present disclosure. Process flow 400 may include UE 115-l, serving base station 105-g and neighbor base station 105-h, which may be examples of a UE 115 and base stations 105 described with reference to FIGS. 1-3.

At 405, UE 115-l may receive a signal from both serving base station 105-g and neighbor base station 105-h. In some examples UE 115-l may identify a base station identification (ID), a transmission power level, a beam ID, and other information based on the received signals. In some examples at least one of the signals is a directional broadcast signal. In some examples at least one of the signals is a directional PSS. In some examples at least one of the signals is a data transmission signal. In some examples at least one of the signals identifies a beam traffic load. In some examples the signals are received via directional beamforming such as directional mmW beams.

At 410, UE 115-l may generate an interference report based on the first transmission and the second transmission. At 415, UE 115-l may transmit the interference report to the serving base station. In some examples the interference report comprises at least a transmission power level, or a reception power level, or a base station ID, or a beam number, or a combination thereof.

At 420, base station 105-g may generate a local interference graph based on the interference report. Base station 105-g may exchange interference information with a neighboring base station based on the local interference graph.

At 425, base station 105-g may exchange interference and scheduling information with neighboring base station 105-h. In some examples the interference information comprises information about at least one beam that interferes with a beam of a neighbor base station. Base station 105-g may update the local interference graph based on the interference information. In some examples the interference information is exchanged via a wired backhaul link. In some examples the interference information is exchanged via a mmW backhaul link.

At 430, base station 105-g may receive scheduling decision from base station 105-h or another base station 105 (e.g., from a base station 105 with a higher scheduling priority if base station scheduling decisions are made based at least in part on some prioritization). For example, base stations 105 with higher priority may schedule a UE 115 and exchange the scheduling decisions with base stations 105 with lower priority. In some examples, the base stations 105 with lower priority make scheduling decisions based at least in part on scheduling decisions made by the base stations 105 with higher priority. In some examples the base station priority is based at least in part on a traffic load, or a random seed, or the interference information, or a UE wait time, or a combination thereof. In some examples the scheduling is based at least in part on a UE priority. In some examples the UE priority is based at least in part on a traffic load, or a random seed, or the interference information, or a UE wait time, or a combination thereof.

At 435, base station 105-g may schedule a transmission based on the exchanged interference information. In some examples the scheduling may be performed in a distributed manner. In some examples, the scheduling is based at least in part on a base station priority. In some examples, the scheduling decision may be based at least in part on scheduling decisions made by base stations 105 with higher priority.

In some examples the scheduling is based at least in part on a centralized controller. Thus, base station 105-g may transmit at least traffic demand information, or local interference information, or a combination thereof to the centralized controller and receive scheduling information from the centralized controller.

At 440, base station 105-g may inform base station 105-h (or another base station 105 with a lower scheduling priority than base station 105-g) about its scheduling decision (and in some cases, the scheduling decisions made by base stations 105 of higher priority) to enable them to make their scheduling decisions. At 445, base station 105-g may transmit data to UE 115-l based on the schedule.

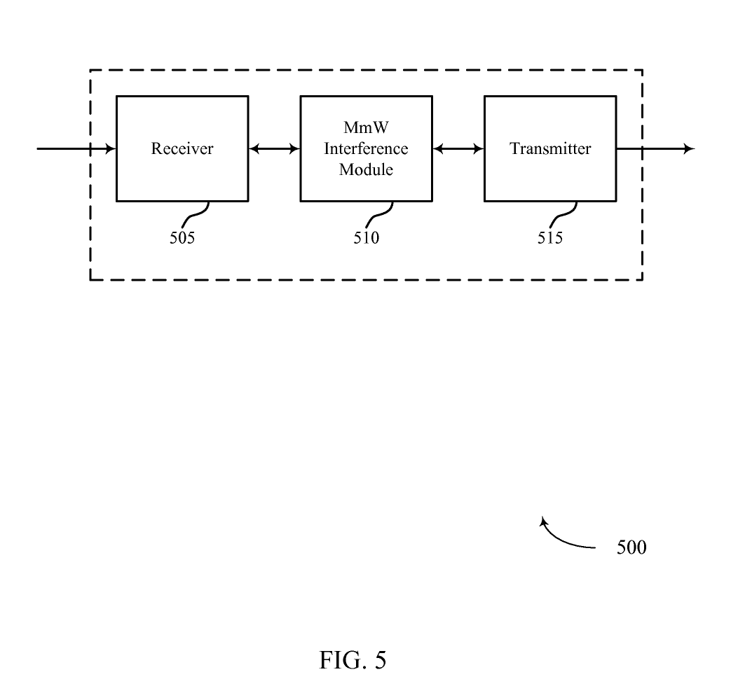

FIG. 5 shows a block diagram of a wireless device 500 configured for signaling for mmW interference and scheduling in accordance with various aspects of the present disclosure. Wireless device 500 may be an example of aspects of a UE 115 described with reference to FIGS. 1-4. Wireless device 500 may include a receiver 505, a mmW interference module 510, or a transmitter 515. Wireless device 500 may also include a processor. Each of these components may be in communication with each other.

The components of wireless device 500 may, individually or collectively, be implemented with at least one application specific integrated circuit (ASIC) adapted to perform some or all of the applicable functions in hardware. Alternatively, the functions may be performed by one or more other processing units (or cores), on at least one IC. In other examples, other types of integrated circuits may be used (e.g., Structured/Platform ASICs, a field programmable gate array (FPGA), or another semi-custom IC), which may be programmed in any manner known in the art. The functions of each unit may also be implemented, in whole or in part, with instructions embodied in a memory, formatted to be executed by one or more general or application-specific processors.

The receiver 505 may receive information such as packets, user data, or control information associated with various information channels (e.g., control channels, data channels, and information related to signaling for mmW interference and scheduling, etc.). Information may be passed on to the mmW interference module 510, and to other components of wireless device 500.

The mmW interference module 510 may receive a first transmission from a first beam of a serving base station using directional beamforming, receive a second transmission from a second beam of a neighboring base station using directional beamforming, generate an interference report based at least in part on the first transmission and the second transmission, and transmit the interference report to the serving base station.

The transmitter 515 may transmit signals received from other components of wireless device 500. In some examples, the transmitter 515 may be collocated with the receiver 505 in a transceiver module. The transmitter 515 may include a single antenna, or it may include a plurality of antennas.

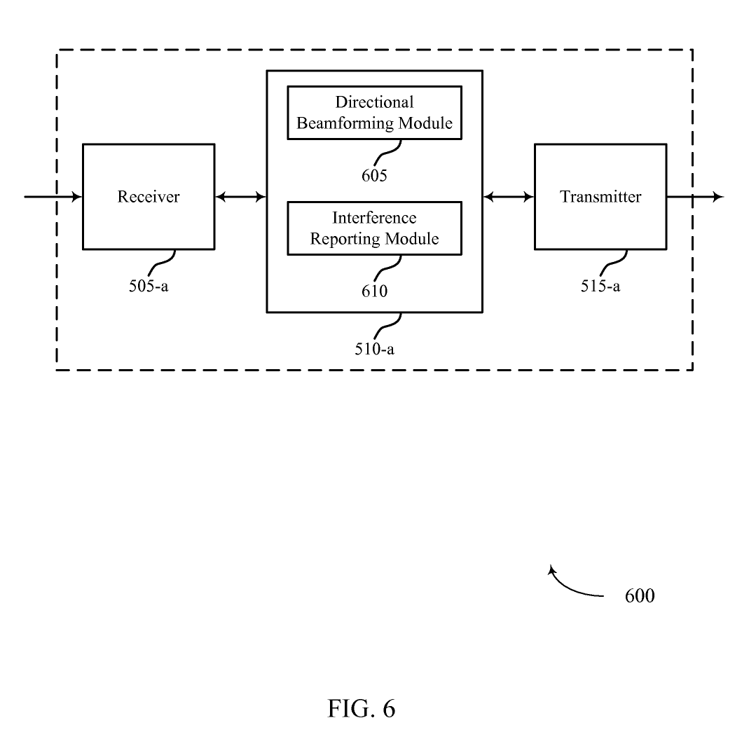

FIG. 6 shows a block diagram of a wireless device 600 for signaling for mmW interference and scheduling in accordance with various aspects of the present disclosure. Wireless device 600 may be an example of aspects of a wireless device 500 or a UE 115 described with reference to FIGS. 1-5. Wireless device 600 may include a receiver 505-a, a mmW interference module 510-a, or a transmitter 515-a. Wireless device 600 may also include a processor. Each of these components may be in communication with each other. The mmW interference module 510-a may also include a directional beamforming module 605, and an interference reporting module 610.

The components of wireless device 600 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 505-a may receive information which may be passed on to mmW interference module 510-a, and to other components of wireless device 600. The mmW interference module 510-a may perform the operations described with reference to FIG. 5. The transmitter 515-a may transmit signals received from other components of wireless device 600.

The directional beamforming module 605 may receive a first transmission from a first beam of a serving base station using directional beamforming as described with reference to FIGS. 2-4. The directional beamforming module 605 may also receive a second transmission from a second beam of a neighboring base station using directional beamforming. In some examples, the first beam and the second beam are mmW beams. In some examples, the signal may be a data transmission signal.

The interference reporting module 610 may generate an interference report based at least in part on the first transmission and the second transmission as described with reference to FIGS. 2-4. The interference reporting module 610 may also transmit the interference report to the serving base station. In some examples, the interference report comprises at least a transmission power level, or a reception power level, or a base station ID, or a beam number, or a combination thereof.

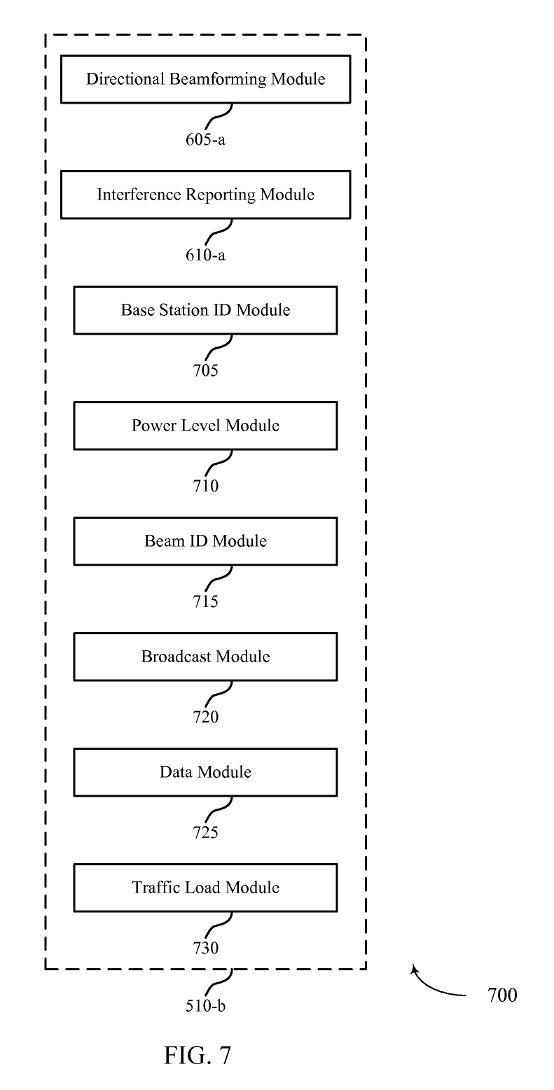

FIG. 7 shows a block diagram 700 of a mmW interference module 510-b which may be a component of a wireless device 500 or a wireless device 600 for signaling for mmW interference and scheduling in accordance with various aspects of the present disclosure. The mmW interference module 510-b may be an example of aspects of a mmW interference module 510 described with reference to FIGS. 5-6. The mmW interference module 510-b may include a directional beamforming module 605-a, and an interference reporting module 610-a. Each of these modules may perform the functions described with reference to FIG. 6. The mmW interference module 510-b may also include a base station ID module 705, a power level module 710, a beam ID module 715, a broadcast module 720, a data module 725, and a traffic load module 730.

The components of the mmW interference module 510-b may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The base station ID module 705 may identify a base station ID based at least in part on the first transmission or the second transmission as described with reference to FIGS. 2-4.

The power level module 710 may determine a transmission power level based at least in part on the first transmission or the second transmission as described with reference to FIGS. 2-4.

The beam ID module 715 may identify a beam ID based at least in part on the first transmission or the second transmission, wherein the interference report comprises the beam ID as described with reference to FIGS. 2-4.

The broadcast module 720 may be configured such that the first transmission or the second transmission may be a directional broadcast signal as described with reference to FIGS. 2-4.

The data module 725 may be configured such that the first transmission or the second transmission may be a data transmission as described with reference to FIGS. 2-4.

The traffic load module 730 may be configured such that the first transmission or the second transmission identifies a beam traffic load as described with reference to FIGS. 2-4.

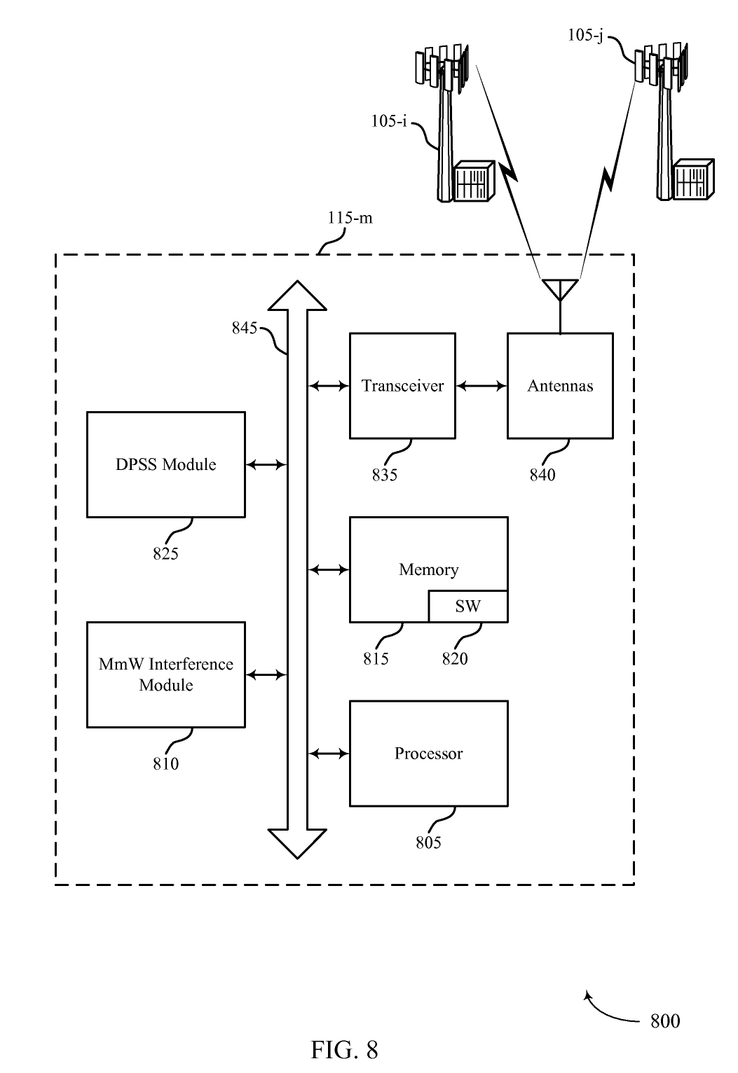

FIG. 8 shows a diagram of a system 800 including a UE 115 configured for signaling for mmW interference and scheduling in accordance with various aspects of the present disclosure. System 800 may include UE 115-m, which may be an example of a wireless device 500, a wireless device 600, or a UE 115 described with reference to FIGS. 1, 2 and 5-7. UE 115-m may include a mmW interference module 810, which may be an example of a mmW interference module 510 described with reference to FIGS. 5-7. UE 115-m may also include a DPSS module 825. UE 115-m may also include components for bi-directional voice and data communications including components for transmitting communications and components for receiving communications. For example, UE 115-m may communicate bi-directionally with base station 105-i or base station 105-j.

The DPSS module 825 may be configured such that a first transmission from a first base station 105 or a second transmission from a second base station 105, such as a directional PSS, may be used to synchronize a timing configuration and enable UE 115-m to proceed with an access procedure as well as generate an interference report as described with reference to FIGS. 1-4.

UE 115-m may also include a processor 805, and memory 815 (including software (SW) 820), a transceiver 835, and one or more antenna(s) 840, each of which may communicate, directly or indirectly, with one another (e.g., via buses 845). The transceiver 835 may communicate bi-directionally, via the antenna(s) 840 or wired or wireless links, with one or more networks, as described above. For example, the transceiver 835 may communicate bi-directionally with a base station 105 or another UE 115. The transceiver 835 may include a modem to modulate packets and provide the modulated packets to the antenna(s) 840 for transmission, and to demodulate packets received from the antenna(s) 840. While UE 115-m may include a single antenna, UE 115-m may also have multiple antennas capable of concurrently transmitting or receiving multiple wireless transmissions.

The memory 815 may include random access memory (RAM) and read only memory (ROM). The memory 815 may store computer-readable, computer-executable software/firmware code 820 including instructions that, when executed, cause the processor 805 to perform various functions described herein (e.g., signaling for mmW interference and scheduling, etc.). Alternatively, the software/firmware code 820 may not be directly executable by the processor 805 but cause a computer (e.g., when compiled and executed) to perform functions described herein. The processor 805 may include an intelligent hardware device, (e.g., a central processing unit (CPU), a microcontroller, an ASIC, etc.)

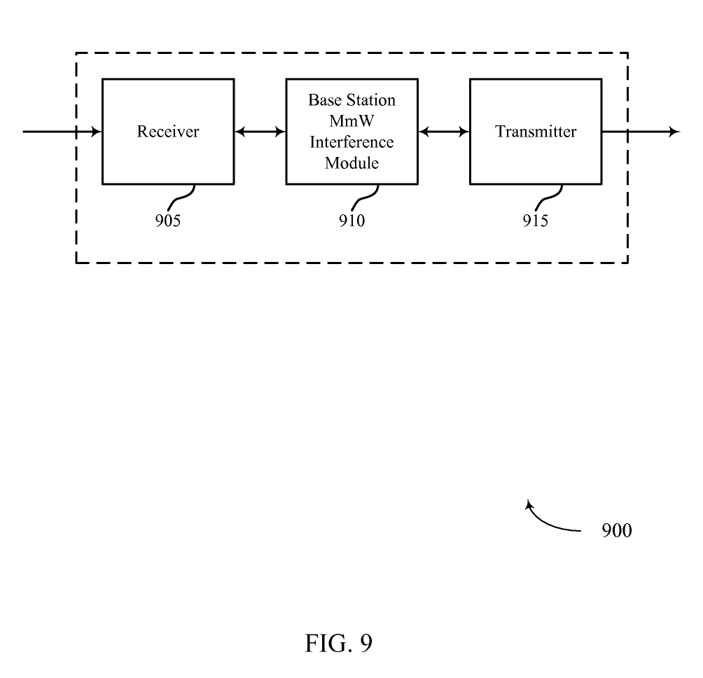

FIG. 9 shows a block diagram of a wireless device 900 configured for signaling for mmW interference and scheduling in accordance with various aspects of the present disclosure. Wireless device 900 may be an example of aspects of a base station 105 described with reference to FIGS. 1-8. Wireless device 900 may include a receiver 905, a base station mmW interference module 910, or a transmitter 915. Wireless device 900 may also include a processor. Each of these components may be in communication with each other.

The components of wireless device 900 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 905 may receive information such as packets, user data, or control information associated with various information channels (e.g., control channels, data channels, and information related to signaling for mmW interference and scheduling, etc.). Information may be passed on to the base station mmW interference module 910, and to other components of wireless device 900.

The base station mmW interference module 910 may transmit a signal to a wireless device using a first beam of a directional beamforming configuration, receive an interference report from the wireless device based at least in part on the transmission of the signal, and generate a local interference graph based at least in part on the interference report.

The transmitter 915 may transmit signals received from other components of wireless device 900. In some examples, the transmitter 915 may be collocated with the receiver 905 in a transceiver module. The transmitter 915 may include a single antenna, or it may include a plurality of antennas.

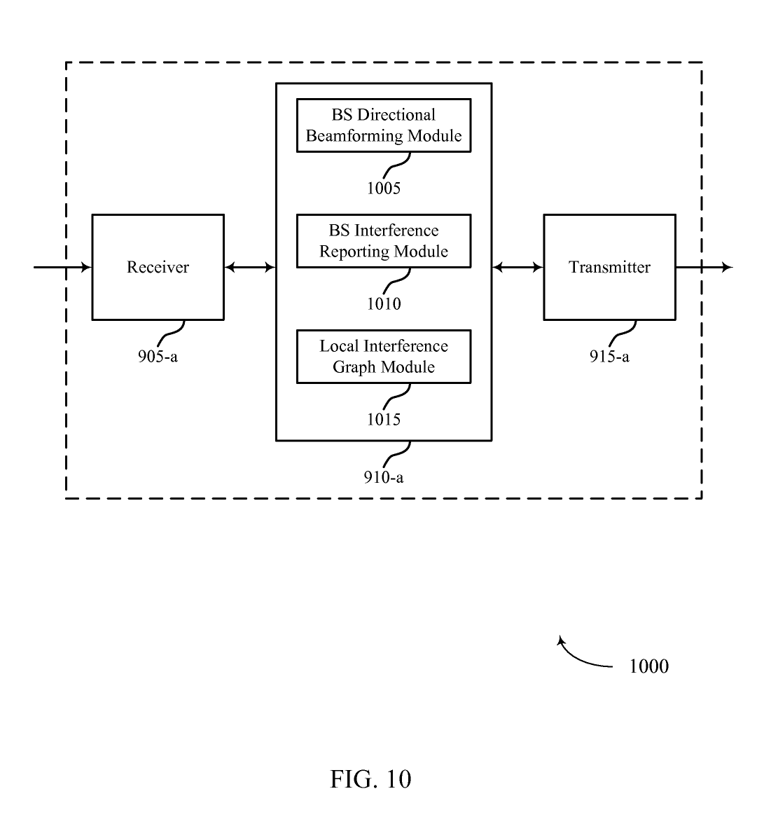

FIG. 10 shows a block diagram of a wireless device 1000 for signaling for mmW interference and scheduling in accordance with various aspects of the present disclosure. Wireless device 1000 may be an example of aspects of a wireless device 900 or a base station 105 described with reference to FIGS. 1-9. Wireless device 1000 may include a receiver 905-a, a base station mmW interference module 910-a, or a transmitter 915-a. Wireless device 1000 may also include a processor. Each of these components may be in communication with each other. The base station mmW interference module 910-a may also include a base station (BS) directional beamforming module 1005, a BS interference reporting module 1010, and a local interference graph module 1015.

The components of wireless device 1000 may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The receiver 905-a may receive information which may be passed on to base station mmW interference module 910-a, and to other components of wireless device 1000. The base station mmW interference module 910-a may perform the operations described with reference to FIG. 9. The transmitter 915-a may transmit signals received from other components of wireless device 1000.

The BS directional beamforming module 1005 may transmit a signal to a wireless device using a first beam of a directional beamforming configuration as described with reference to FIGS. 2-4.

The BS interference reporting module 1010 may receive an interference report from the wireless device based at least in part on the transmission of the signal as described with reference to FIGS. 2-4.

The local interference graph module 1015 may generate a local interference graph based at least in part on the interference report as described with reference to FIGS. 2-4. The local interference graph module 1015 may also update the local interference graph based at least in part on the interference information.

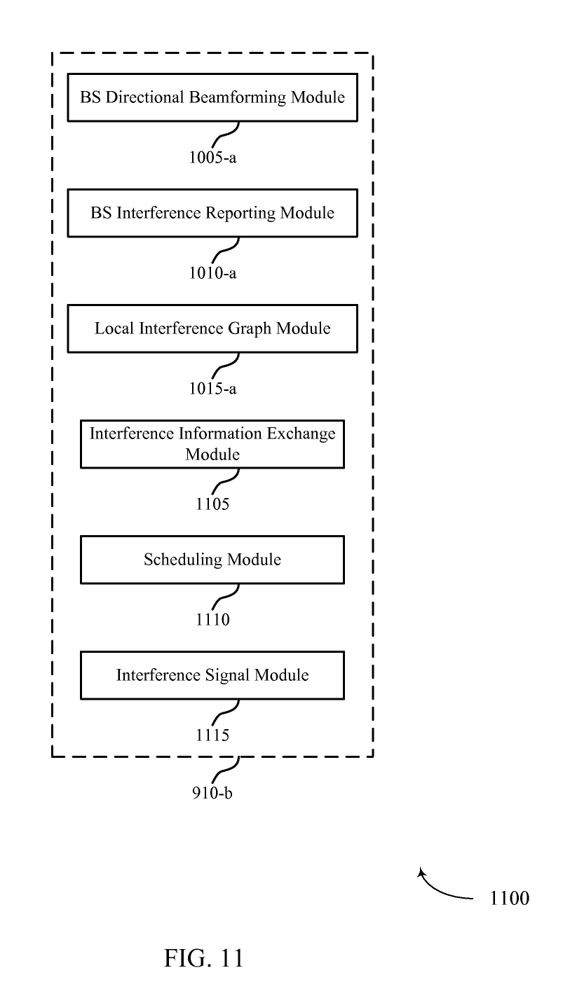

FIG. 11 shows a block diagram 1100 of a base station mmW interference module 910-b which may be a component of a wireless device 900 or a wireless device 1000 for signaling for mmW interference and scheduling in accordance with various aspects of the present disclosure. The base station mmW interference module 910-b may be an example of aspects of a base station mmW interference module 910 described with reference to FIGS. 9-10. The base station mmW interference module 910-b may include a BS directional beamforming module 1005-a, a BS interference reporting module 1010-a, and a local interference graph module 1015-a. Each of these modules may perform the functions described with reference to FIG. 10. The base station mmW interference module 910-b may also include an interference information exchange module 1105, a scheduling module 1110, and an interference signal module 1115.

The components of the base station mmW interference module 910-b may, individually or collectively, be implemented with at least one ASIC adapted to perform some or all of the applicable functions in hardware. Alternatively, the functions may be performed by one or more other processing units (or cores), on at least one IC. In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The interference information exchange module 1105 may exchange interference information with a neighboring base station based at least in part on the local interference graph as described with reference to FIGS. 2-4. In some examples, the interference information comprises information about at least one beam that interferes with a beam of a neighbor base station. In some examples, the interference information may be exchanged via a wired backhaul link. In some examples, the interference information may be exchanged via a mmW backhaul link.

The scheduling module 1110 may schedule a transmission based at least in part on the exchanged interference information as described with reference to FIGS. 2-4. In some examples, the scheduling may be performed in a distributed manner. The scheduling module 1110 may also exchange scheduling information with the neighboring base station, wherein scheduling the transmission is based at least in part on the exchanged scheduling information. In some examples, the scheduling may be based at least in part on a base station priority. In some examples, the base station priority may be based at least in part on a traffic load, or a random seed, or the interference information, or a UE wait time, or a combination thereof. In some examples, the scheduling may be based at least in part on a UE priority. In some examples, the UE priority may be based at least in part on a traffic load, or a random seed, or the interference information, or a UE wait time, or a combination thereof. In some examples, the scheduling may be based at least in part on a centralized controller. The scheduling module 1110 may transmit at least traffic demand information, or local interference information, or a combination thereof to the centralized controller. The scheduling module 1110 may also receive scheduling information from the centralized controller, wherein the scheduling is based at least in part on the received scheduling information.

The interference signal module 1115 may be configured such that the signal may be a directional broadcast signal as described with reference to FIGS. 2-4. In some examples, the signal may be a directional PSS. In some examples, the signal comprises at least a base station ID, or a beam number, or a transmission power level, or a beam load indicator, or a combination thereof.

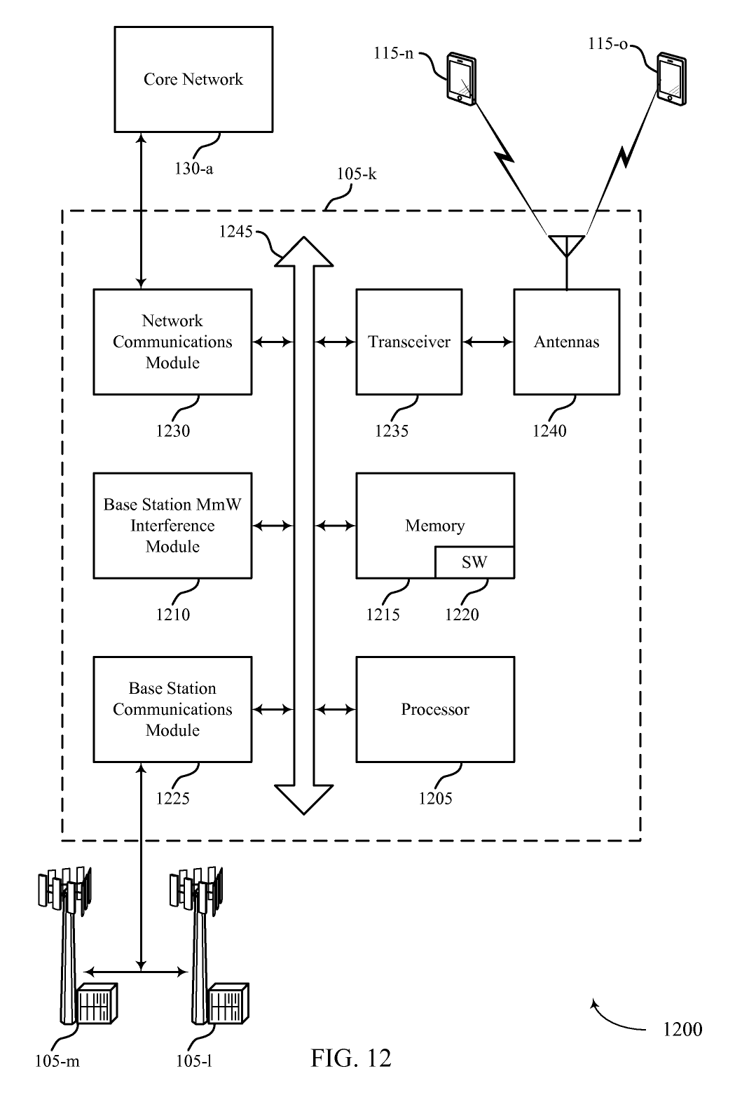

FIG. 12 shows a diagram of a system 1200 including a base station 105 configured for signaling for mmW interference and scheduling in accordance with various aspects of the present disclosure. System 1200 may include base station 105-k, which may be an example of a wireless device 900, a wireless device 1000, or a base station 105 described with reference to FIGS. 1, 2 and 9-11. Base Station 105-k may include a base station mmW interference module 1210, which may be an example of a base station mmW interference module 910 described with reference to FIGS. 9-11. Base Station 105-k may also include components for bi-directional voice and data communications including components for transmitting communications and components for receiving communications. For example, base station 105-k may communicate bi-directionally with UE 115-n or UE 115-o.

In some cases, base station 105-k may have one or more wired backhaul links Base station 105-k may have a wired backhaul link (e.g., 51 interface, etc.) to the core network 130. Base station 105-k may also communicate with other base stations 105, such as base station 105-l and base station 105-m via inter-base station backhaul links (e.g., an X2 interface). Each of the base stations 105 may communicate with UEs 115 using the same or different wireless communications technologies. In some cases, base station 105-k may communicate with other base stations such as 105-l or 105-m utilizing base station communications module 1225. In some examples, base station communications module 1225 may provide an X2 interface within an LTE/LTE-A wireless communication network technology to provide communication between some of the base stations 105. In some examples, base station 105-k may communicate with other base stations through core network 130. In some cases, base station 105-k may communicate with the core network 130 through network communications module 1230.

The base station 105-k may include a processor 1205, memory 1215 (including software (SW) 1220), transceiver 1235, and antenna(s) 1240, which each may be in communication, directly or indirectly, with one another (e.g., over bus system 1245). The transceivers 1235 may be configured to communicate bi-directionally, via the antenna(s) 1240, with the UEs 115, which may be multi-mode devices. The transceiver 1235 (or other components of the base station 105-k) may also be configured to communicate bi-directionally, via the antennas 1240, with one or more other base stations (not shown). The transceiver 1235 may include a modem configured to modulate packets and provide the modulated packets to the antennas 1240 for transmission, and to demodulate packets received from the antennas 1240. The base station 105-k may include multiple transceivers 1235, each with one or more associated antennas 1240. The transceiver may be an example of a combined receiver 905 and transmitter 915 of FIG. 9.

The memory 1215 may include RAM and ROM. The memory 1215 may also store computer-readable, computer-executable software code 1220 containing instructions that are configured to, when executed, cause the processor 1205 to perform various functions described herein (e.g., signaling for mmW interference and scheduling, selecting coverage enhancement techniques, call processing, database management, message routing, etc.). Alternatively, the software code 1220 may not be directly executable by the processor 1205 but be configured to cause the computer, e.g., when compiled and executed, to perform functions described herein. The processor 1205 may include an intelligent hardware device, e.g., a CPU, a microcontroller, an ASIC, etc. The processor 1205 may include various special purpose processors such as encoders, queue processing modules, base band processors, radio head controllers, digital signal processor (DSPs), and the like.

The base station communications module 1225 may manage communications with other base stations 105. The base station communications module 1225 may include a controller or scheduler for controlling communications with UEs 115 in cooperation with other base stations 105. For example, the base station communications module 1225 may coordinate scheduling for transmissions to UEs 115 for various interference mitigation techniques such as beamforming or joint transmission.

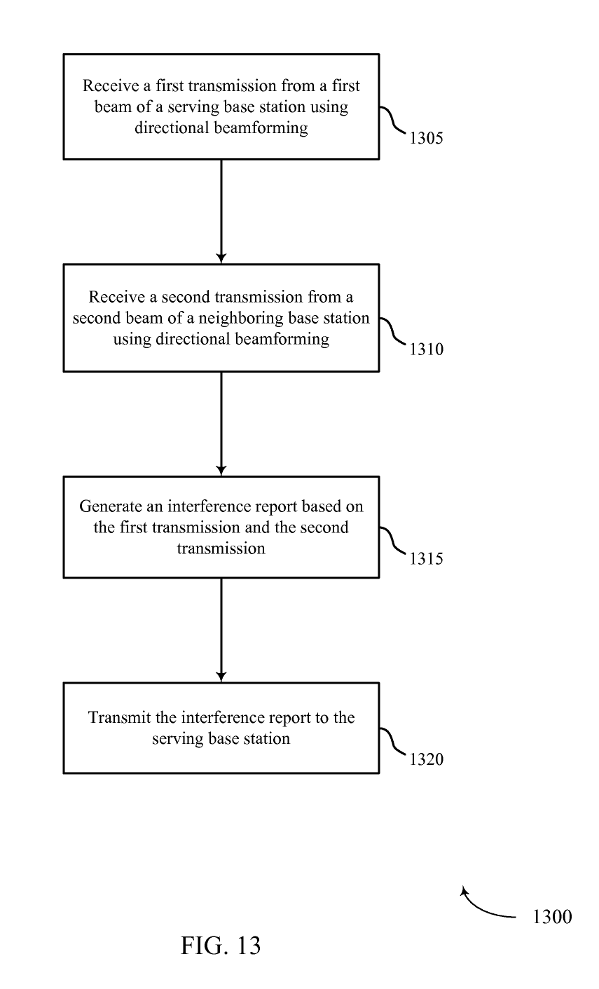

FIG. 13 shows a flowchart illustrating a method 1300 for signaling for mmW interference and scheduling in accordance with various aspects of the present disclosure. The operations of method 1300 may be implemented by a UE 115 or its components as described with reference to FIGS. 1-12. For example, the operations of method 1300 may be performed by the mmW interference module 510, 810 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware.

At block 1305, the UE 115 may receive a first transmission from a first beam of a serving base station using directional beamforming as described with reference to FIGS. 2-4. In certain examples, the operations of block 1305 may be performed by the directional beamforming module 605 as described with reference to FIG. 6.

At block 1310, the UE 115 may receive a second transmission from a second beam of a neighboring base station using directional beamforming as described with reference to FIGS. 2-4. In certain examples, the operations of block 1310 may be performed by the directional beamforming module 605 as described with reference to FIG. 6.

At block 1315, the UE 115 may generate an interference report based at least in part on the first transmission and the second transmission as described with reference to FIGS. 2-4. In certain examples, the operations of block 1315 may be performed by the interference reporting module 610 as described with reference to FIG. 6.

At block 1320, the UE 115 may transmit the interference report to the serving base station as described with reference to FIGS. 2-4. In certain examples, the operations of block 1320 may be performed by the interference reporting module 610 as described with reference to FIG. 6.

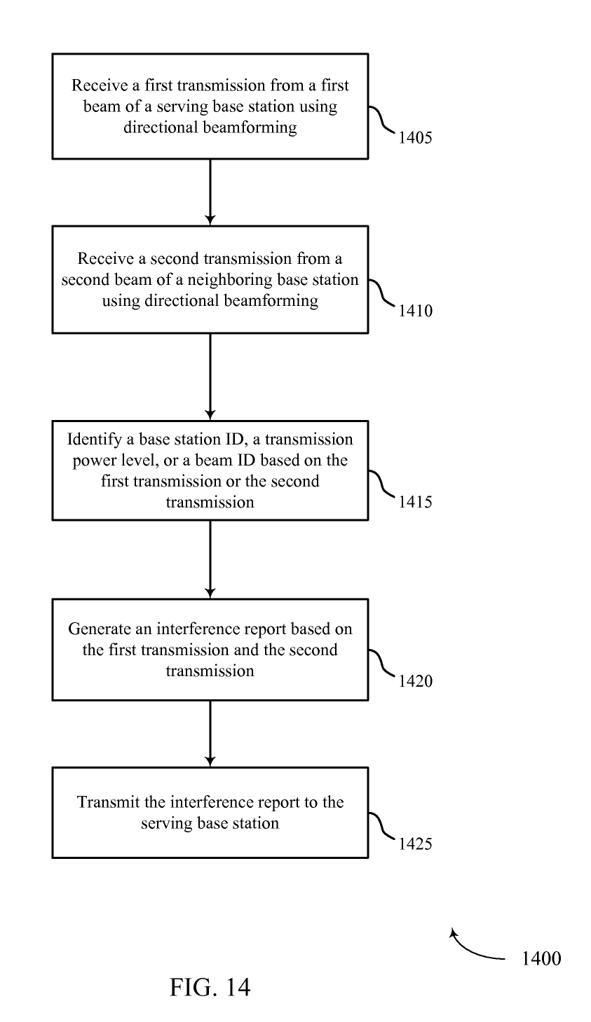

FIG. 14 shows a flowchart illustrating a method 1400 for signaling for mmW interference and scheduling in accordance with various aspects of the present disclosure. The operations of method 1400 may be implemented by a UE 115 or its components as described with reference to FIGS. 1-12. For example, the operations of method 1400 may be performed by the mmW interference module 510, 810 as described with reference to FIGS. 5-8. In some examples, a UE 115 may execute a set of codes to control the functional elements of the UE 115 to perform the functions described below. Additionally or alternatively, the UE 115 may perform aspects the functions described below using special-purpose hardware. The method 1400 may also incorporate aspects of method 1300 of FIG. 13.

At block 1405, the UE 115 may receive a first transmission from a first beam of a serving base station using directional beamforming as described with reference to FIGS. 2-4. In certain examples, the operations of block 1405 may be performed by the directional beamforming module 605 as described with reference to FIG. 6.

At block 1410, the UE 115 may receive a second transmission from a second beam of a neighboring base station using directional beamforming as described with reference to FIGS. 2-4. In certain examples, the operations of block 1410 may be performed by the directional beamforming module 605 as described with reference to FIG. 6.

At block 1415, the UE 115 may identify a base station ID, a transmission power level, and/or a beam ID based at least in part on the first transmission or the second transmission as described with reference to FIGS. 2-4. In certain examples, the operations of block 1415 may be performed by the base station ID module 705, the power level module 710, and/or the beam ID module 715 as described with reference to FIG. 7.

At block 1420, the UE 115 may generate an interference report based at least in part on the first transmission and the second transmission as described with reference to FIGS. 2-4. In certain examples, the operations of block 1420 may be performed by the interference reporting module 610 as described with reference to FIG. 6.

At block 1425, the UE 115 may transmit the interference report to the serving base station as described with reference to FIGS. 2-4. In certain examples, the operations of block 1425 may be performed by the interference reporting module 610 as described with reference to FIG. 6.

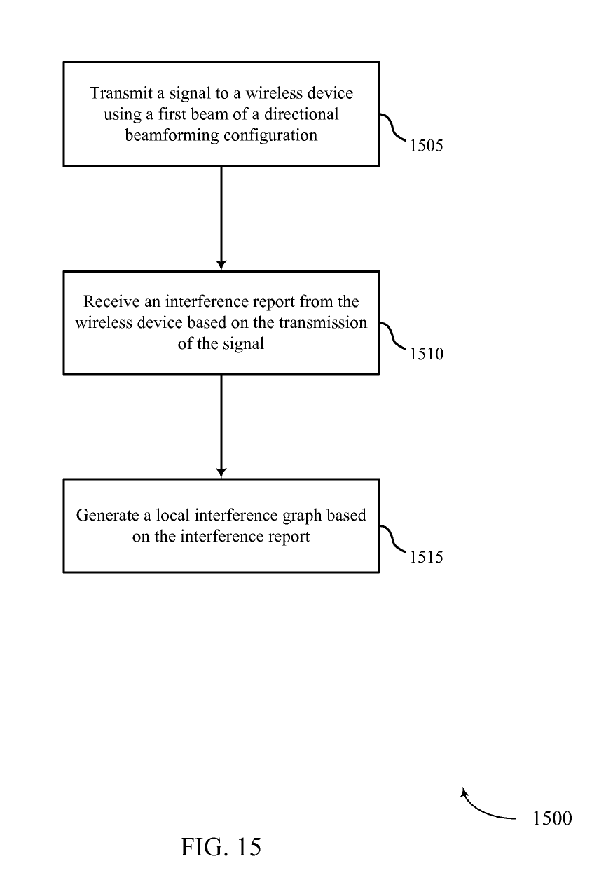

FIG. 15 shows a flowchart illustrating a method 1500 for signaling for mmW interference and scheduling in accordance with various aspects of the present disclosure. The operations of method 1500 may be implemented by a base station 105 or its components as described with reference to FIGS. 1-12. For example, the operations of method 1500 may be performed by the base station mmW interference module 910, 1210 as described with reference to FIGS. 9-12. In some examples, a base station 105 may execute a set of codes to control the functional elements of the base station 105 to perform the functions described below. Additionally or alternatively, the base station 105 may perform aspects the functions described below using special-purpose hardware. The method 1500 may also incorporate aspects of methods 1300, and 1400 of FIGS. 13-14.

At block 1505, the base station 105 may transmit a signal to a wireless device using a first beam of a directional beamforming configuration as described with reference to FIGS. 2-4. In certain examples, the operations of block 1505 may be performed by the BS directional beamforming module 1005 as described with reference to FIG. 10.

At block 1510, the base station 105 may receive an interference report from the wireless device based at least in part on the transmission of the signal as described with reference to FIGS. 2-4. In certain examples, the operations of block 1510 may be performed by the BS interference reporting module 1010 as described with reference to FIG. 10.

At block 1515, the base station 105 may generate a local interference graph based at least in part on the interference report as described with reference to FIGS. 2-4. In certain examples, the operations of block 1515 may be performed by the local interference graph module 1015 as described with reference to FIG. 10.

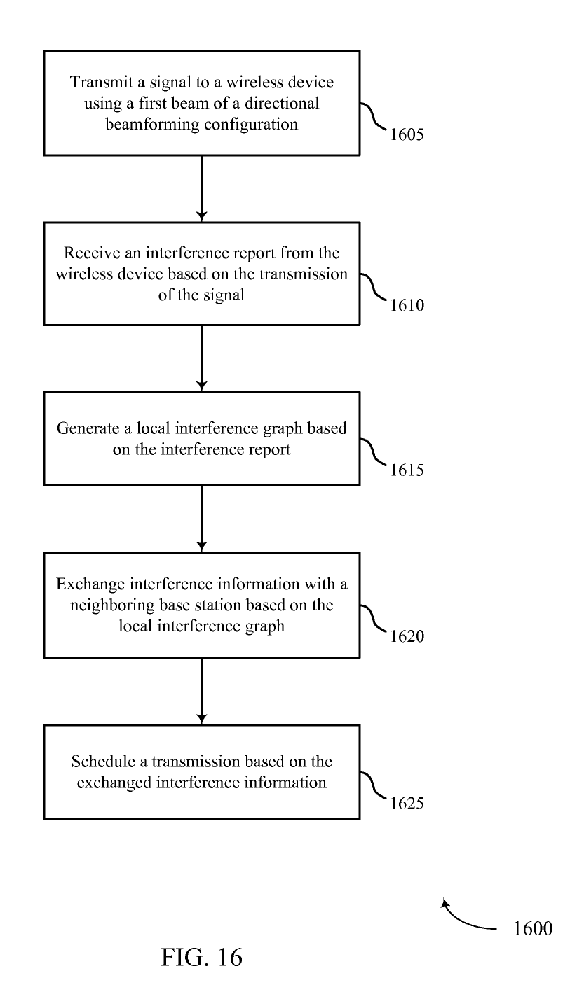

FIG. 16 shows a flowchart illustrating a method 1600 for signaling for mmW interference and scheduling in accordance with various aspects of the present disclosure. The operations of method 1600 may be implemented by a base station 105 or its components as described with reference to FIGS. 1-12. For example, the operations of method 1600 may be performed by the base station mmW interference module 910, 1210 as described with reference to FIGS. 9-12. In some examples, a base station 105 may execute a set of codes to control the functional elements of the base station 105 to perform the functions described below. Additionally or alternatively, the base station 105 may perform aspects the functions described below using special-purpose hardware. The method 1600 may also incorporate aspects of methods 1300, 1400, and 1500 of FIGS. 13-15.

At block 1605, the base station 105 may transmit a signal to a wireless device using a first beam of a directional beamforming configuration as described with reference to FIGS. 2-4. In certain examples, the operations of block 1605 may be performed by the BS directional beamforming module 1005 as described with reference to FIG. 10.

At block 1610, the base station 105 may receive an interference report from the wireless device based at least in part on the transmission of the signal as described with reference to FIGS. 2-4. In certain examples, the operations of block 1610 may be performed by the BS interference reporting module 1010 as described with reference to FIG. 10.

At block 1615, the base station 105 may generate a local interference graph based at least in part on the interference report as described with reference to FIGS. 2-4. In certain examples, the operations of block 1615 may be performed by the local interference graph module 1015 as described with reference to FIG. 10.

At block 1620, the base station 105 may exchange interference information with a neighboring base station based at least in part on the local interference graph as described with reference to FIGS. 2-4. In certain examples, the operations of block 1620 may be performed by the interference information exchange module 1105 as described with reference to FIG. 11.

At block 1625, the base station 105 may schedule a transmission based at least in part on the exchanged interference information as described with reference to FIGS. 2-4. In certain examples, the operations of block 1625 may be performed by the scheduling module 1110 as described with reference to FIG. 11.

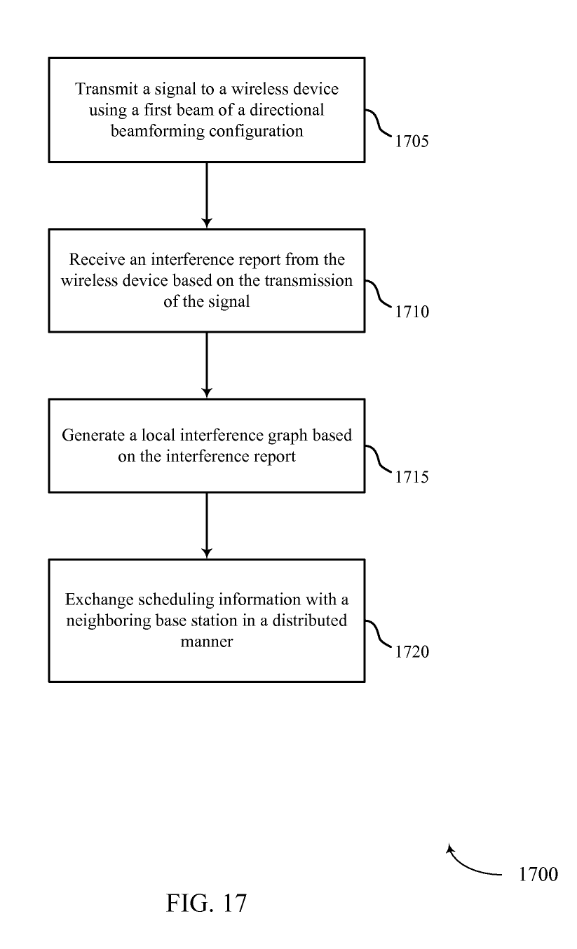

FIG. 17 shows a flowchart illustrating a method 1700 for signaling for mmW interference and scheduling in accordance with various aspects of the present disclosure. The operations of method 1700 may be implemented by a base station 105 or its components as described with reference to FIGS. 1-12. For example, the operations of method 1700 may be performed by the base station mmW interference module 910, 1210 as described with reference to FIGS. 9-12. In some examples, a base station 105 may execute a set of codes to control the functional elements of the base station 105 to perform the functions described below. Additionally or alternatively, the base station 105 may perform aspects the functions described below using special-purpose hardware. The method 1700 may also incorporate aspects of methods 1300, 1400, 1500, and 1600 of FIGS. 13-16.

At block 1705, the base station 105 may transmit a signal to a wireless device using a first beam of a directional beamforming configuration as described with reference to FIGS. 2-4. In certain examples, the operations of block 1705 may be performed by the BS directional beamforming module 1005 as described with reference to FIG. 10.

At block 1710, the base station 105 may receive an interference report from the wireless device based at least in part on the transmission of the signal as described with reference to FIGS. 2-4. In certain examples, the operations of block 1710 may be performed by the BS interference reporting module 1010 as described with reference to FIG. 10.

At block 1715, the base station 105 may generate a local interference graph based at least in part on the interference report as described with reference to FIGS. 2-4. In certain examples, the operations of block 1715 may be performed by the local interference graph module 1015 as described with reference to FIG. 10.

In some cases, scheduling is based at least in part on a distributed scheduling configuration. Thus, at block 1720, the base station 105 may exchange scheduling information with a neighboring base station in a distributed manner as described with reference to FIGS. 2-4. In certain examples, the operations of block 1720 may be performed by the scheduling module 1110 as described with reference to FIG. 11.

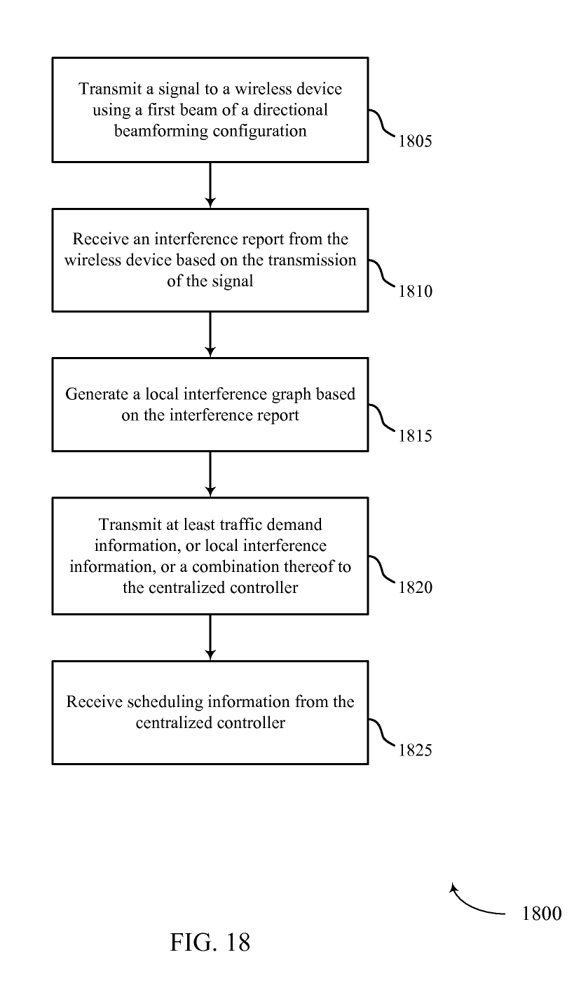

FIG. 18 shows a flowchart illustrating a method 1800 for signaling for mmW interference and scheduling in accordance with various aspects of the present disclosure. The operations of method 1800 may be implemented by a base station 105 or its components as described with reference to FIGS. 1-12. For example, the operations of method 1800 may be performed by the base station mmW interference module 910, 1210 as described with reference to FIGS. 9-12. In some examples, a base station 105 may execute a set of codes to control the functional elements of the base station 105 to perform the functions described below. Additionally or alternatively, the base station 105 may perform aspects the functions described below using special-purpose hardware. The method 1800 may also incorporate aspects of methods 1300, 1400, 1500, 1600, and 1700 of FIGS. 13-17.

At block 1805, the base station 105 may transmit a signal to a wireless device using a first beam of a directional beamforming configuration as described with reference to FIGS. 2-4. In certain examples, the operations of block 1805 may be performed by the BS directional beamforming module 1005 as described with reference to FIG. 10.

At block 1810, the base station 105 may receive an interference report from the wireless device based at least in part on the transmission of the signal as described with reference to FIGS. 2-4. In certain examples, the operations of block 1810 may be performed by the BS interference reporting module 1010 as described with reference to FIG. 10.

At block 1815, the base station 105 may generate a local interference graph based at least in part on the interference report as described with reference to FIGS. 2-4. In certain examples, the operations of block 1815 may be performed by the local interference graph module 1015 as described with reference to FIG. 10.

In some cases, the scheduling is based at least in part on a centralized controller. Thus, at block 1820, the base station 105 may transmit at least traffic demand information, or local interference information, or a combination thereof to the centralized controller as described with reference to FIGS. 2-4. In certain examples, the operations of block 1820 may be performed by the scheduling module 1110 as described with reference to FIG. 11.

At block 1825, the base station 105 may receive scheduling information from the centralized controller, wherein the scheduling is based at least in part on the received scheduling information as described with reference to FIGS. 2-4. In certain examples, the operations of block 1825 may be performed by the scheduling module 1110 as described with reference to FIG. 11.

Thus, methods 1300, 1400, 1500, 1600, 1700, and 1800 may provide for signaling for mmW interference and scheduling. It should be noted that methods 1300, 1400, 1500, 1600, 1700, and 1800 describe possible implementation, and that the operations and the steps may be rearranged or otherwise modified such that other implementations are possible. In some examples, aspects from two or more of the methods 1300, 1400, 1500, 1600, 1700, and 1800 may be combined.

The detailed description set forth above in connection with the appended drawings describes exemplary configurations and does not represent all the examples that may be implemented or that are within the scope of the claims. The term “example” or “exemplary” used throughout this description means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). Long Term Evolution (LTE) and LTE-Advanced (LTE-A) are new releases of UMTS that use E-UTRA. UTRA, E-UTRA, UMTS, LTE, LTE-A, and Global System for Mobile communications (GSM) are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of wireless communication, comprising:
receiving a first transmission from a first beam of a serving base station using directional beamforming;
receiving a second transmission from a second beam of a neighboring base station using directional beamforming;
generating an interference report based at least in part on the first transmission and the second transmission; and
transmitting the interference report to the serving base station.

2. The method of claim 1, further comprising:
identifying a base station identification (ID) based at least in part on the first transmission or the second transmission.

3. The method of claim 1, further comprising:
determining a transmission power level based at least in part on the first transmission or the second transmission.

4. The method of claim 1, further comprising:
identifying a beam ID based at least in part on the first transmission or the second transmission, wherein the interference report comprises the beam ID.

5. The method of claim 1, wherein the first transmission or the second transmission is a directional broadcast signal.

6. The method of claim 5, wherein the first transmission or the second transmission is a directional primary synchronization signal (PSS).

7. The method of claim 1, wherein the first transmission or the second transmission is a data transmission.

8. The method of claim 1, wherein the first transmission or the second transmission identifies a beam traffic load.

9. The method of claim 1, wherein the first beam and the second beam are millimeter wave (mmW) beams.

10. A method of wireless communication, comprising:
transmitting a signal to a wireless device using a first beam of a directional beamforming configuration;
receiving an interference report from the wireless device based at least in part on the transmission of the signal; and
generating a local interference graph based at least in part on the interference report.

11. The method of claim 10, further comprising:
exchanging interference information with a neighboring base station based at least in part on the local interference graph.

12. The method of claim 11, further comprising:
scheduling a transmission based at least in part on the exchanged interference information.

13. The method of claim 12, wherein the scheduling is performed in a distributed manner.

14. The method of claim 13, further comprising:
exchanging scheduling information with the neighboring base station, wherein scheduling the transmission is based at least in part on the exchanged scheduling information.

15. The method of claim 14, wherein the scheduling is based at least in part on a base station priority.

16. The method of claim 15, wherein the base station priority is based at least in part on a traffic load, or a random seed, or the interference information, or a user equipment (UE) wait time, or a combination thereof.

17. The method of claim 14, wherein the scheduling is based at least in part on a user equipment (UE) priority.

18. The method of claim 17, wherein the UE priority is based at least in part on a traffic load, or a random seed, or the interference information, or a UE wait time, or a combination thereof.

19. The method of claim 12, wherein the scheduling is based at least in part on a centralized controller.

20. The method of claim 19, further comprising:
transmitting at least traffic demand information, or local interference information, or a combination thereof to the centralized controller; and
receiving scheduling information from the centralized controller, wherein the scheduling is based at least in part on the received scheduling information.

21. The method of claim 11, wherein the interference information comprises information about at least one beam that interferes with a beam of a neighbor base station.

22. The method of claim 11, further comprising:
updating the local interference graph based at least in part on the interference information.

23. The method of claim 10, wherein the signal is a directional broadcast signal.

24. The method of claim 23, wherein the signal is a directional PSS.

25. The method of claim 10, wherein the signal is a data transmission signal.

26. The method of claim 10, wherein the signal comprises at least a base station ID, or a beam number, or a transmission power level, or a beam load indicator, or a combination thereof.

27. The method of claim 10, wherein the interference report comprises at least a transmission power level, or a reception power level, or a base station ID, or a beam number, or a combination thereof.

28. The method of claim 10, wherein the first beam is a mmW beam.

29. An apparatus for wireless communication, comprising:
a processor;
memory in electronic communication with the processor; and
instructions stored in the memory and operable, when executed by the processor, to cause the processor to:
receive a first transmission from a first beam of a serving base station using directional beamforming;
receive a second transmission from a second beam of a neighboring base station using directional beamforming;
generate an interference report based at least in part on the first transmission and the second transmission; and
transmit the interference report to the serving base station.

30. An apparatus for wireless communication, comprising:
a processor;
memory in electronic communication with the processor; and
instructions stored in the memory and operable, when executed by the processor, to cause the apparatus to:
transmit a signal to a wireless device using a first beam of a directional beamforming configuration;
receive an interference report from the wireless device based at least in part on the transmission of the signal; and
generate a local interference graph based at least in part on the interference report.
